(19) United States
(12) Patent Application Publication
(10) Pub. No.: US 2013/0069474 A1
(43) Pub. Date: Mar. 21, 2013

(54) COMPOSITE CONDUCTOR INSULATION

(71) Applicants: Colin J. Hamer, Noblesville, IN (US); Koon Hoong Wan, Indianapolis, IN (US)

(72) Inventors: Colin J. Hamer, Noblesville, IN (US); Koon Hoong Wan, Indianapolis, IN (US)

(73) Assignee: Remy Technologies, L.L.C., Pendleton, IN (US)

(21) Appl. No.: 13/235,048

(22) Filed: Sep. 16, 2011

(51) Int. Cl. H02K 3/34; H01B 3/42; H01B 13/32; H01B 3/00

(52) U.S. Cl. 310/208; 174/110 R; 174/110 SR; 156/56

(57) ABSTRACT

An electric machine having insulated conductor wires and a method of insulating the conductor wires. The conductor wires include an electrically conductive core and an electrical insulation portion. The electrical insulation portion includes an electrical insulation coating layer and at least one electrical insulation wrap layer.

### BACKGROUND AND SUMMARY OF THE DISCLOSURE

The present invention relates generally to electric machines and, more particularly, to the insulation of conductor wires of a stator assembly within electric machines.

Electric machines may be used for a variety of applications, including in connection with automobile power trains. For example, a conventional automobile may use an electric machine as a starting motor for an internal combustion engine, or as an alternator to generate electricity and deliver power to vehicle accessories and/or charge a vehicle's battery.

An illustrative electric machine includes a rotor and a stator. The stator is comprised of a stator stack and a plurality of conductor wires, or windings, that are inserted into the stator stack. The stator interacts with the rotor through magnetic fields to convert electric energy to mechanical energy, or to convert mechanical energy to electric energy.

The windings may be comprised of a conductive core and an electrical insulation surrounding the core. Typical electrical insulation may include an enamel coating that is applied to the core before inserting the windings into the stator stack. However, defects such as pinholes or other weak spots may be formed when the enamel is applied to the conductive core. Defects in the enamel may result in enlarged cracks when the windings are bent or shaped during assembly of the stator, particularly in outer portions of bends. Such defects or cracks in the enamel may not effectively insulate the winding and may cause the electric machine to short.

Another form of electrical insulation is a wrap or tape comprised of an insulation material. The tape is wrapped around the conductive core before inserting the windings into the stator stack. However, as the windings are bent during assembly of the stator, the tape may buckle along the inner portion of a bend. As such, the windings may not be sufficiently insulated where the buckling occurs. Additionally, the tape may be less abrasion-resistant than an enamel.

The present disclosure relates to an electric machine comprising a support and a plurality of conductor wires positioned within the support. Each of the conductor wires has a conductive core, an inner coating layer of an insulation material adjacent to the conductive core, an intermediate wrap layer of an insulation material adjacent to the inner layer, and an outer wrap layer of an insulation material adjacent to the intermediate wrap layer such that the intermediate wrap layer is positioned between the inner coating layer and the outer wrap layer. The intermediate wrap layer has a first orientation relative to a longitudinal axis of the conductive core and the outer wrap layer has a second orientation relative to the longitudinal axis of the conductive core.

According to another illustrative embodiment of the present disclosure, an electric machine comprises a plurality of conductor wires received within a plurality of apertures of the machine. Each of the conductor wires has an insulation portion around a conductive core. The insulation portion includes a coating layer, at least one wrap layer, and a bond between the coating layer and the at least one wrap layer.

An illustrative method of insulating a conductor wire of an electric machine comprises the steps of providing a conductive core and applying a liquid insulation coating around the conductive core. The illustrative method further includes the step of applying at least one layer of insulation wrap around the conductive core.

According to another illustrative embodiment of the present disclosure, a conductor wire for use in an electric machine comprises an electrically conductive core, an electrically or electrical insulation enamel around the conductive core, and at least one layer of insulation wrap around the conductive core.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The foregoing aspects and many of the intended advantages of this invention will become more readily appreciated as the same becomes better understood by reference to the following detailed description when taken in conjunction with the accompanying drawings.

FIG. 1A is a front perspective view of an insertion end of an illustrative stator assembly;

FIG. 1B is a front perspective view of a connection end of the illustrative stator assembly of FIG. 1A;

FIG. 2 is a cross-sectional view of the illustrative stator assembly, taken along line 2-2 of FIG. 1B; and

FIG. 3 is a cross-sectional view of conductor wires in the illustrative stator assembly, taken along line 3-3 of FIG. 2;

FIG. 4 is a front perspective view of a conductor wire of the illustrative stator assembly having a generally U-shaped configuration;

FIG. 5 is a cross-sectional view of a portion of the conductor wire of FIG. 2, showing a conductive core surrounded by an insulation portion;

FIGS. 6A-6D show illustrative steps for insulating the conductive core of the conductor wire;

FIG. 7 is a front perspective view of an end of the conductor wire of FIG. 3 having a second layer of insulation wrap surrounding a first layer of insulation wrap (shown in phantom); and

FIG. 8 is a schematic representation of an illustrative method of the present disclosure.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplifications set out herein illustrate embodiments of the invention, and such exemplifications are not to be construed as limiting the scope of the invention in any manner.

### DETAILED DESCRIPTION OF THE DRAWINGS

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

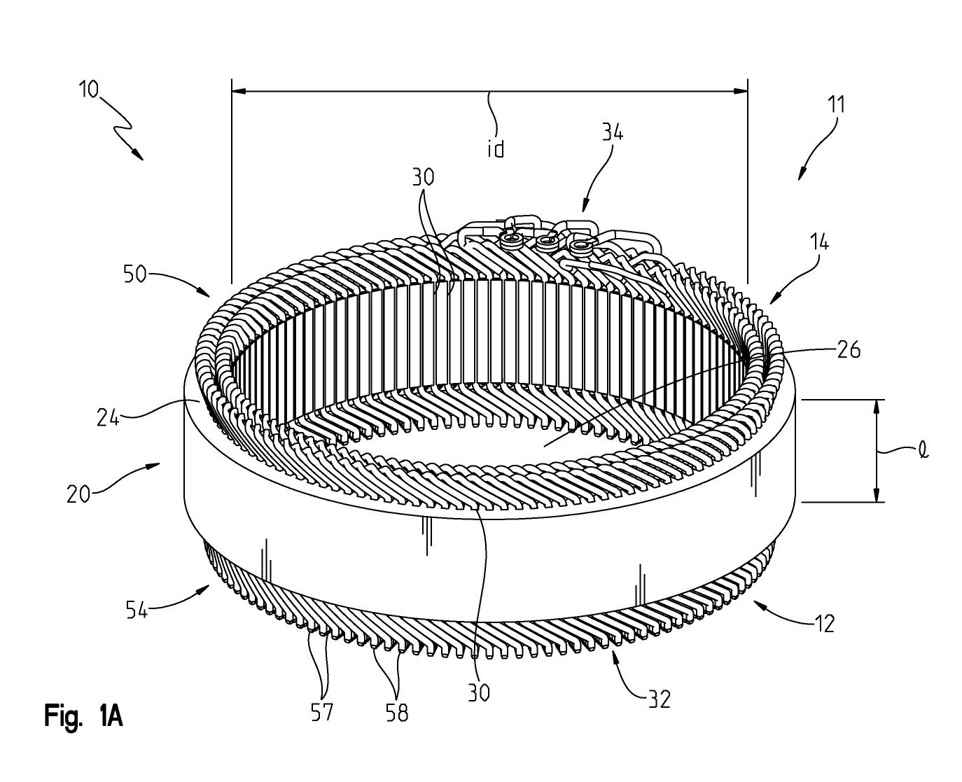

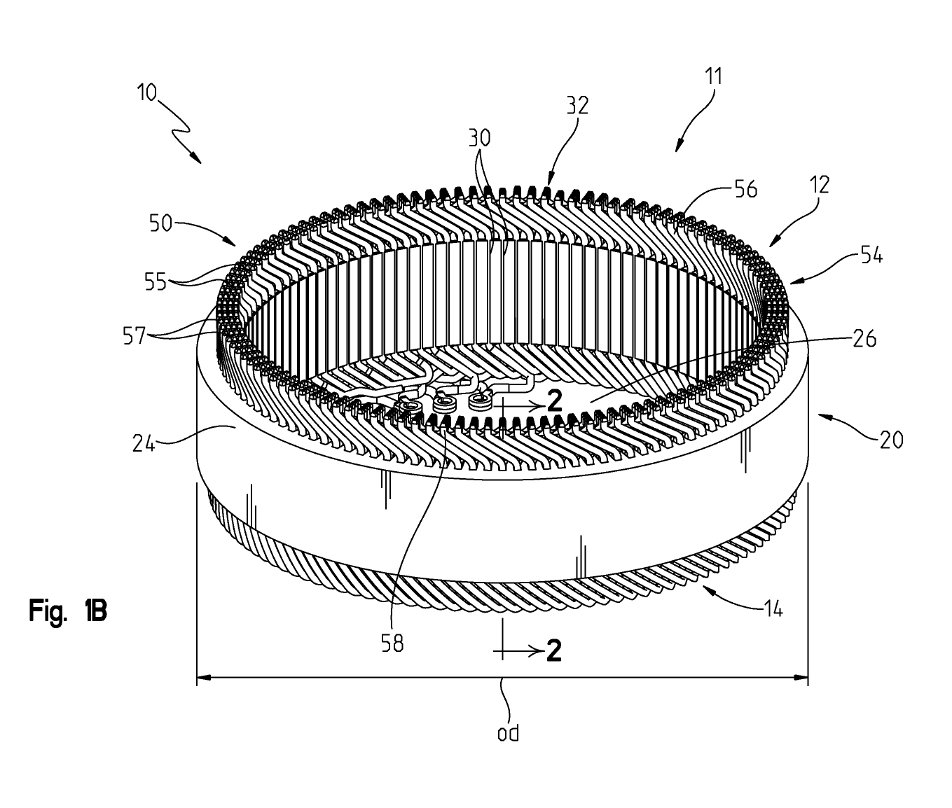

Referring initially to FIGS. 1A and 1B, an illustrative stator assembly 10 of an electric machine 11 is shown. More particularly, FIG. 1A shows the insertion end 14 of the stator assembly 10 and FIG. 1B shows the connector end 12 of the stator assembly 10. The electric machine 11 when used as a motor (such as a starting motor) includes the stator assembly 10 operably coupled to a rotor (not shown) for converting electric energy to mechanical energy. The electric machine 11 may also be used as an alternator to generate electricity and deliver power, for example, to vehicle accessories and/or to charge a vehicle's battery.

The stator assembly 10 is illustratively comprised of a support or stator stack 20, and a plurality of conductor wires, or windings 50. The stator stack 20 includes a cylindrical wall 24 having an open center portion 26. The cylindrical wall 24 may include one or more lamination stacks or layers. The cylindrical wall 24 may be comprised of silicon steel, which reduces hysteresis and eddy current losses during operation of an electric machine 11. Alternatively, the cylindrical wall 24 may be comprised of a solid powered metal body. Furthermore, the stator stack 20 may include a metal (e.g., steel) frame (not shown).

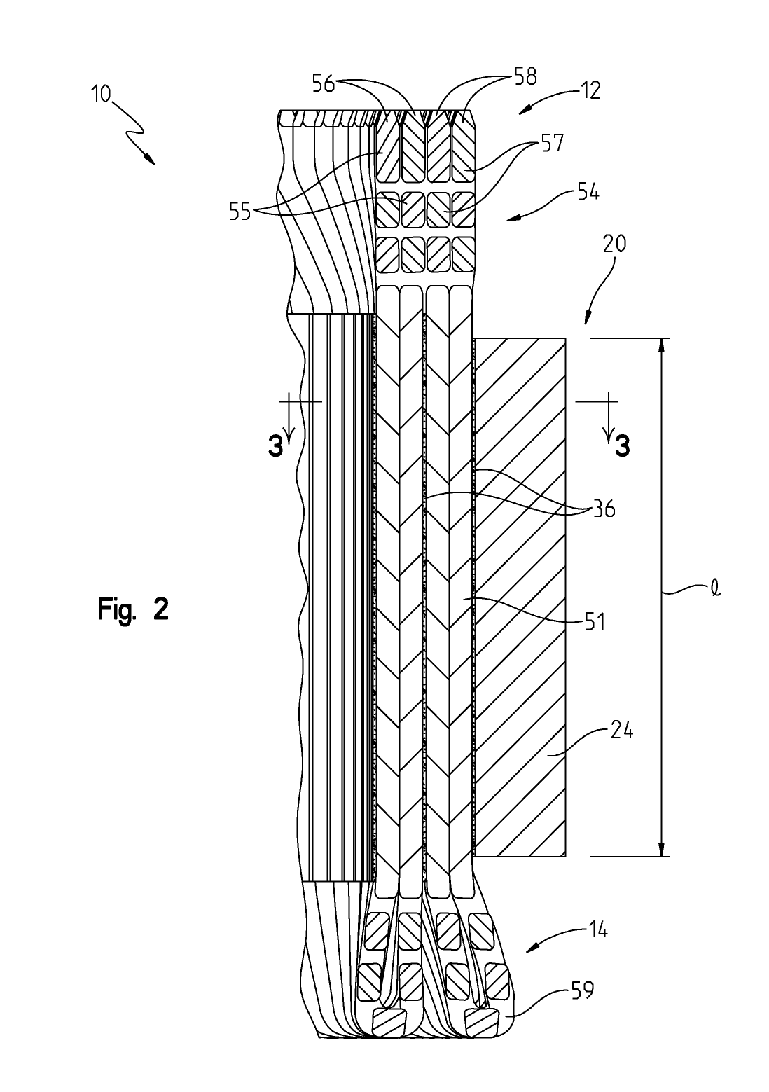

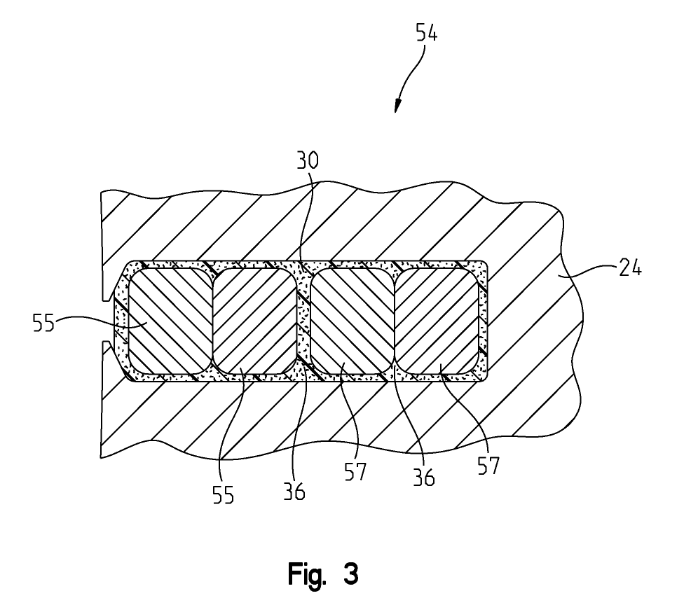

With respect to FIGS. 2 and 3, the cylindrical wall 24 of the stator stack 20 illustratively includes 60 circumferentially-spaced, axially-extending slots 30 through which the conductor wires 50 are received. More particularly, each illustrative slot 30 has a rectangular cross-section to support the ends of the conductor wires 50. The slots 30 may include an insulating material or fill 36 (e.g., foam, gel, spray) that fills voids or spaces between the conductor wires 50 and the cylindrical wall 24 of the stator stack 20, along with voids between conductor wires 50.

Alternatively, the cylindrical wall 24 may include a plurality of radially-spaced slots 30 forming a plurality of concentric rows. As further detailed herein, the slots 30 each illustratively support at least a portion of conductor wires 50. The slots 30 extend along the length l of the cylindrical wall 24 of the stator stack 20.

As disclosed in FIGS. 1A and 1B, the stator assembly 10 includes a commons region 32 and a specials region 34, which are comprised of the conductor wires 50. The specials region 34 determines whether the stator assembly 10 is in parallel or series. As is known in the art, the conductor wires 50 within the specials region 34 may include neutral conductor wires, phase conductor wires, and cross-over conductor wires. The specials region 32 also may include other conductor wires 50.

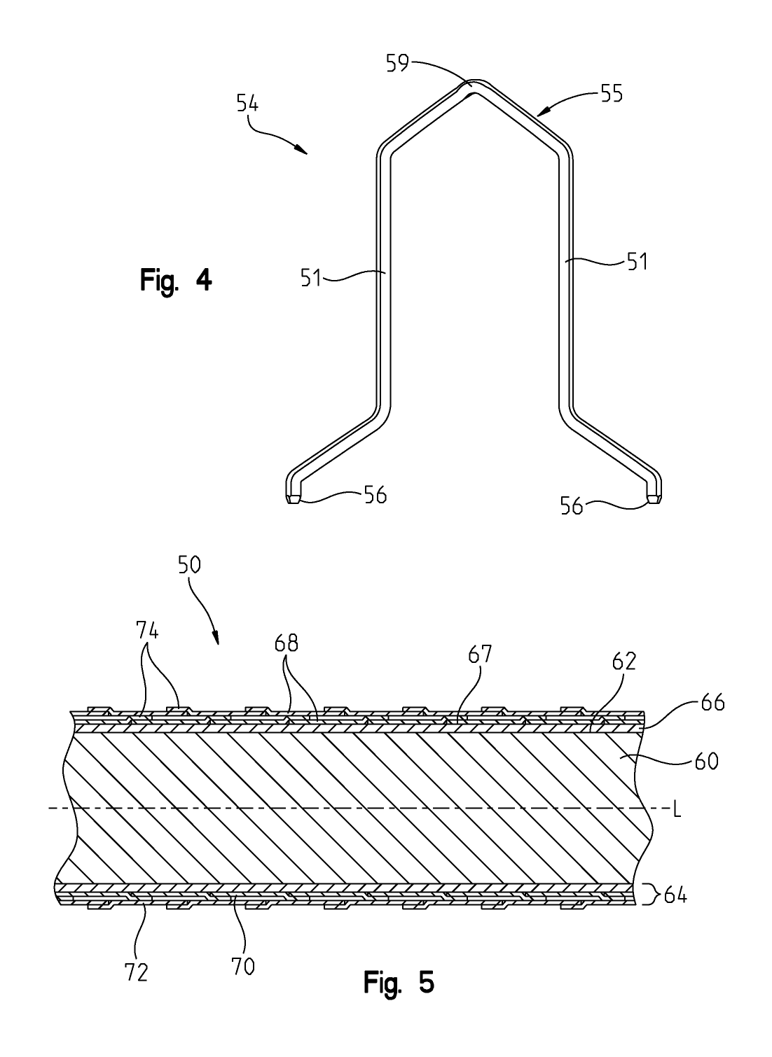

The conductor wires 50 within the commons region 32 include a plurality of commons conductor wires 54 positioned within slots 30 of the stator stack 20. Referring to FIG. 4, a single commons conductor wire 54 is shown. The commons conductor wires 54 may have different maximum voltage capacities (e.g., approximately 120 volts (V)). Additionally, the operational temperature of the common conductor wires 54 may be from approximately −44° F. (approximately −42° C.) to approximately 428° F. (approximately 220° C.).

Illustratively, the commons conductor wires 54 have a rectangular cross-section (FIG. 4). The efficiency of an electric machine 11 may be improved by increasing the slot-fill-ratio (SFR) of the machine. The SFR is a comparison of the aggregate cross-sectional area of bare copper conductors in one of the slots 30 and the cross-sectional area of the slot 30 itself. If an electric machine 11 has a high SFR, the cross-sectional area of the conductor wires 54 reduces the phase resistance and the resistance of the windings (i.e., power loss) for a given size of the slots 30. Conductor wires 54 illustratively have a rectangular cross-section, rather than a circular cross-section, in order to contribute to a higher SFR for the machine. Therefore, the efficiency of the machine may be improved.

Illustratively, FIGS. 2 and 3 disclose that the commons region 32 of the stator assembly 10 includes a plurality of inner commons conductor wires 55 and a plurality of outer commons conductor wires 57. The illustrative embodiment of the present disclosure includes 60 inner commons conductor wires 55 and 60 outer commons conductor wires 57. A typical stator assembly 10 may include different numbers of conductor wires 50 (e.g., 120 conductor wires 50 or 240 conductor wires 50), depending on the desired power, magnetic, and other operational requirements of the stator assembly 10.

The ends 56 of the inner commons conductor wires 55 and the ends 58 of the outer commons conductor wires 57 illustratively extend from the connection end 14 of the stator assembly 10 (FIGS. 1A, 1B). Each commons conductor wire 54 may be bent or shaped into a more compact configuration during assembly of the stator assembly 10. The commons conductor wires 54 may be shaped according to the teachings of U.S. Pat. No. 6,894,417 to Cai et al., which issued on May 17, 2005, and is assigned to Remy Inc. of Anderson, Ind., the disclosure of which is expressly incorporated by reference herein. More particularly, the commons conductor wires 54 are bent to form a hairpin-shape, or U-shape (FIG. 4), however, the commons conductor wires 54 may be bent into other shapes. Referring further to FIG. 4, the illustrative hairpin shape of an inner commons conductor wire 55 defines two legs 51 extending from a U-shaped end turn 59 and terminating at ends 56. The illustrative outer commons conductor wires 57 have the same general shape as the inner commons conductor wires 55. As shown in FIGS. 1A and 1B, the U-shaped end turn 59 is exposed at the insertion end 14 of the stator assembly 10. The legs 51 of the commons conductor wires 54 may be bent in a clockwise or counter-clockwise direction to form the end turn 59.

With continued reference to FIGS. 2 and 3, each end 56, 58 of the commons conductor wires 54 is received within one of the slots 30 of the stator stack 20 such that each end 56, 58 is staggered, or “interleaved” (i.e., positioned through a different slot 30 with respect to adjacent commons conductor wires 54). More particularly, the ends 56 of the inner commons conductor wires 55 are circumferentially staggered within a radially inward portion of the slot 30. Additionally, the ends 58 of the outer commons conductor wires 57 are circumferentially staggered within a radially outward portion of the slot 30.

Referring to FIG. 1B, the ends 56, 58 of the commons conductor wires 54 extending from the slots 30 are interconnected to form at least one circuit. Additionally, the commons conductor wires 54 are interconnected with the conductor wires 50 of the specials region 34 to complete the circuit. For example, the conductor wires 50 may interconnect to form a single-phase circuit, a two-phase circuit, or a three-phase circuit. More particularly, the conductor wires 50 may be interconnected through welding or other similar conventional techniques in order to form a circuit.

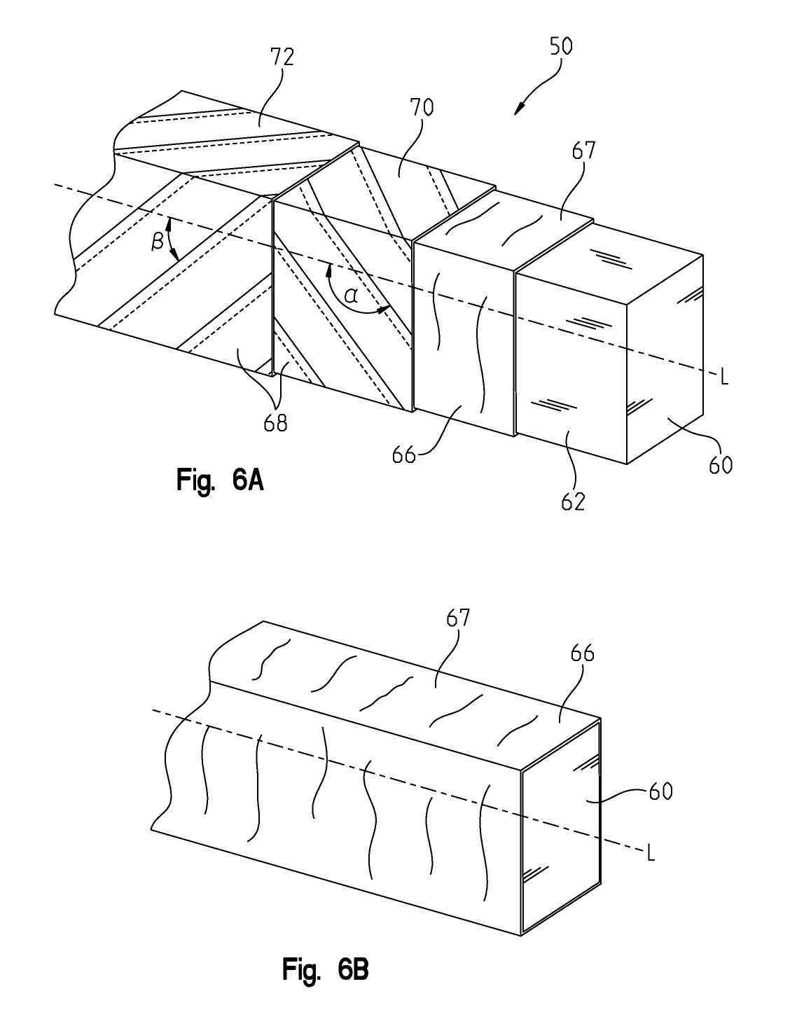

Referring to FIG. 5, the conductor wires 50 each illustratively include an electrically conductive portion or core 60 and an electrically non-conductive or insulation portion 64. The conductor wires 50 are insulated from each other and the stator stack 20 in order to prevent the electric machine 11 from shorting out as current flows through the conductor wires 50. The conductive core 60 is comprised of an electrically conductive material, such as a metal (e.g., copper). As detailed above, the conductive core 60 illustratively has a rectangular cross-section, however, the conductive core 60 may have other cross-sectional shapes (e.g., square, circular).

The insulation portion 64 extends around an outer surface 62 of the conductive core 60 and is comprised of electrically insulating materials, such as polymers, paper, fiberglass sleeves, or Kevlar® brand aramid fibers (from DuPont™) However, as detailed above, certain conventional insulation materials and methods may have reduced effectiveness, particularly after bending of the conductor wires 50 during assembly of the stator assembly 10. For example, defects or imperfections, such as pinholes within enamel coatings may crack or break along the outer portion of a bend when the conductor wires 50 are bent and shaped into a compact arrangement during the assembly process. Similarly, insulation tape may buckle or pull away from an inner portion of a bend when the conductor wires 50 are bent and arranged in this compact manner. As such, when only a coating or an insulation tape are used to insulate the conductor wires 50, defects in the insulation portion 64 (i.e., pinholes, cracks, and buckling) that often occur at the inner or outer portions of the bends of the conductor wire 50 may not effectively insulate the conductive core 60 of the conductor wires 50 and may cause the electric machine 11 to short when current flows through the conductor wires 50.

As shown in FIG. 5, the insulation portion 64 of the illustrative conductive wires 50 includes a plurality of layers. The material properties of the insulation portion 64 determine the operating environment of the conductor wires 50. More particularly, the insulation portion 64 includes a section or layer of coating or enamel 66 and a section or layer of tape or wrap 68. Illustratively, the wrap 68 is wound or wrapped around the coating 66 such that the coating 66 is intermediate the conductive core 60 and the wrap 68. An alternative embodiment includes covering the conductive core 60 with the wrap 68 and subsequently applying the coating 66 to an outer surface of the wrap 68 such that the wrap 68 is intermediate the conductive core 60 and the coating 66.

The coating 66 may be comprised of an electrically non-conductive material, such as at least one polymeric electrical insulation material, for example, polyimide-based materials, polyamide-imide-based materials, polyurethane-based materials, and polyester-based materials. Exemplary coating materials may be wire enamels, such as Voltatex® available from DuPont™. Other conventional coatings also may be applied to the conductive core 60. The thickness of the coating 66 may be approximately 0.002 inches (approximately 0.05 millimeters). Additionally, there may be several layers of the coating 66 applied to the conductive core 60 in order to achieve the desired thickness before the coating 66 is wrapped with the wrap 68. Any layer of the coating 66 may be comprised of the same insulation material as the previous layer. Alternatively, any layer of coating 66 may be comprised of a different insulation material. The coating 66 is applied to the conductive core 60 through conventional coating methods. As further detailed herein, the coating 66 may be applied as a liquid to the conductive core 60 and cured in an oven. The coating material, method, and thickness are chosen according to the specifications of the material, the capacity of the conductor wires 50, the size of the stator stack 20, and the application of the electric machine 11.

Similarly, the wrap 68 may be comprised of an electrically non-conductive material, such as at least one polymeric electrical insulation material, for example, polyimide-based materials, polyamide-imide-based materials, polyurethane-based materials, and polyester-based materials. For example, the wrap 68 may be Kapton® polyimide film available from DuPont™. The wrap 68 may be the same material as the coating 66 or may be a different insulation material. Illustratively, the wrap 68 is in solid form when applied to the coating 66 and has a width substantially greater than its thickness. The wrap 68 may be wound or wrapped around the coating 66 after the coating 66 has cured or immediately after the coating 66 is applied to the conductive core 60 (i.e., while the coating 66 is still viscous). The wrap 68 may have a thickness of approximately 0.001 inches (0.0254 millimeter). The width of the wrap 68 illustratively may be approximately 0.375 inches (approximately 10 millimeters) to approximately 0.5 inches (approximately 13 millimeters).

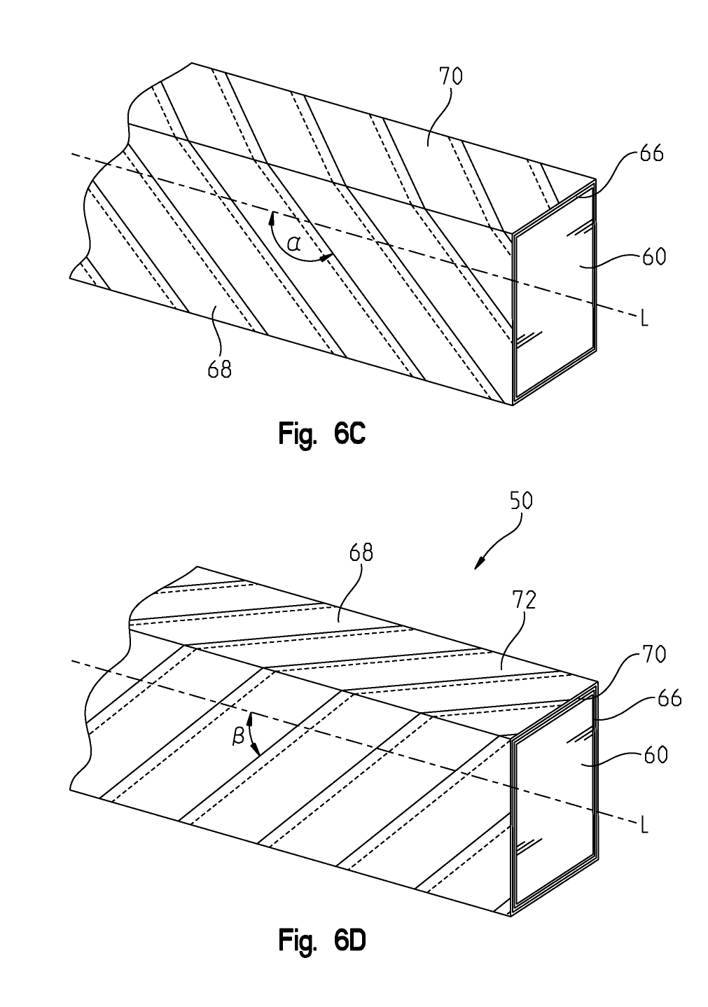

With reference to FIG. 6A, at least one layer of wrap 68 extends over the coating 66. Illustratively, the wrap 68 includes a first or intermediate wrap layer 70 and a second or outer wrap layer 72. The first wrap layer 70 is applied in a first orientation and the second wrap layer 72 is applied in a second orientation. Alternatively, the first and second wrap layers 70, 72 may be applied in the same orientation. More particularly, the illustrative first wrap layer 70 is applied at an angle α with respect to a longitudinal axis L of the conductive core 60. The illustrative angle α of the first orientation may be greater than 0° and less than 180° relative to the longitudinal axis L. In certain illustrative embodiments, angle α may be between approximately 135° and approximately 170°, and is approximately 135° as shown in FIG. 6A. An angle β of the second orientation may be greater than 0° and less than 180° relative to the longitudinal axis L. In certain illustrative embodiments, angle β may be between approximately 10° and approximately 45°, and is approximately 45° as shown in FIG. 6A. The angular orientations of the first and second wrap layers 70 and 72 are illustratively offset by approximately 90° (as defined by angle α-angle β). It may be appreciated that the respective angular orientations of the wrap layers 70, 72 may be reversed, such that the angle α is between approximately 10° and approximately 45°, and the angle β may be between approximately 135° and approximately 170°.

An alternative embodiment of the conductor wires 50 of the present disclosure may include the first and/or second layers 70, 72 of wrap 68 applied coaxially with the longitudinal axis L of the conductive core 60, such that the wrap 68 is parallel with the longitudinal axis L (i.e., the angles α, β of the first and second layers 70, 72, respectively, are approximately 0° and/or 180°. Another alternative embodiment includes both the first and second layers 70, 72 of the wrap 68 applied perpendicularly from an upper side or a lower side of the conductive wire 50.

The first and second layers 70, 72 of wrap 68 may be applied to the conductor wire 50 in an overlapping manner, as denoted by the raised portions of the first and second layers 70, 72 of FIG. 5 and the phantom lines of FIGS. 6C and 6D. More particularly, the first layer 70 of the wrap 68 is illustratively applied to the coating 66 such that each time the first layer 70 is wrapped around the coating 66, the first layer 70 overlaps a portion of the first layer 70 that was previously applied to the coating 66. The overlapped portion 74 ensures that the coating 66 is not exposed and, therefore, if there are any pinholes or other defects in the coating 66, the conductor wire 50 is still insulated by the wrap 68 because the overlapped wrap 68 covers these defects. As such, the thickness of the overlapped portion 74 of the wrap 68 may be twice the thickness of the wrap 68 in a non-overlapped portion. Likewise, the second layer 72 of the wrap 68 is applied to the first layer 70 of the wrap 68 in the same overlapping manner. The angular orientation of angles α, β of the respective first and second orientations of the wrap 68 provide the desire overlapping, illustratively, approximately 10% to approximately 75% of overlap per layers 70, 72. An adhesive may secure the first wrap layer 70 to the coating 66, and the second wrap layer 72 to the first wrap layer 70. In certain illustrative embodiments, the wrap layers 70 and 72 may comprise a tape having a adhesive backing on a rear surface thereof.

The illustrative insulation portion 64 may have a thickness of approximately 0.004 inches (0.1 millimeters) to approximately 0.008 inches (0.2 millimeters). The thickness of the insulation portion 64 is calculated by adding the thickness of the illustrative coating layer (i.e., approximately 0.05 millimeters), the thickness of the overlapped portion 74 of the illustrative first layer 70 of the wrap 68 (i.e., approximately 0.025 millimeters×2=approximately 0.05 millimeters), and the thickness of the overlapped portion 74 of the illustrative second layer 72 of the wrap 68 (i.e., approximately 0.025 millimeters×2=approximately 0.05 millimeters).

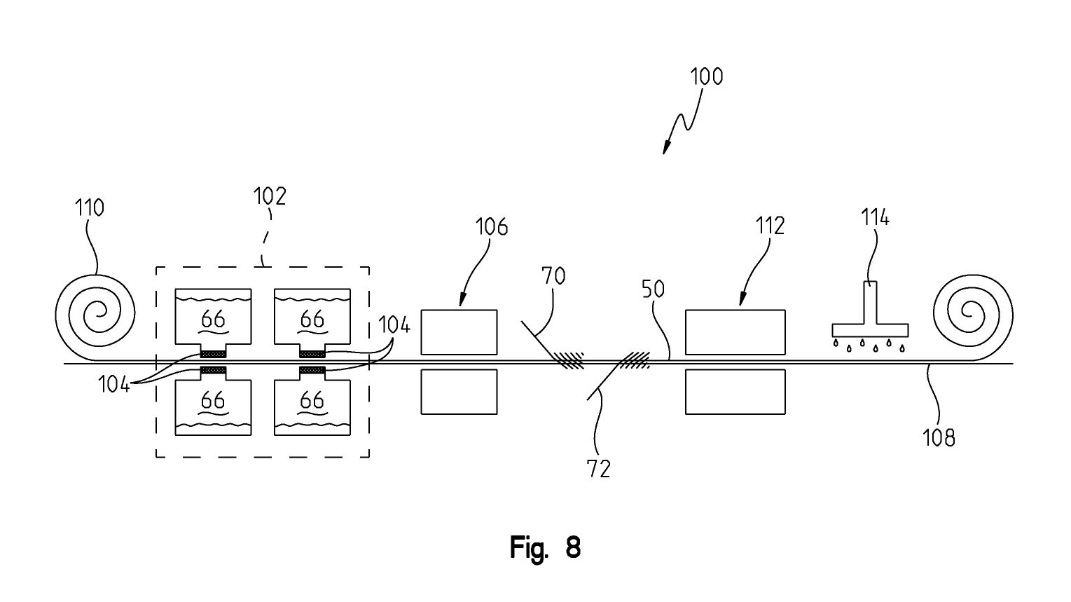

Referring to FIG. 8, the conductive core 60 may be insulated in the following illustrative steps. As shown in FIGS. 6A and 8, the insulation process begins with the conductive core 60. The conductive core 60 may initially start as bulk rolls 110 of conductive wire that are unrolled in order to linearly feed the conductive wire through a coating process. For example, the conductive core 60 may be positioned on a conveyor belt 108 and fed into a conveyor system 100 which applies the coating 66 in liquid form to the conductive core 60 by way of sponges 104 as the conductive core 60 travels along the conveyor belt 108. Referring to FIGS. 6B and 8, after the coating 66 is applied to the conductive core 60, the conductive core 60 may pass through an oven 106 to cure. The coating process may be repeated until the desired properties of the coating 66 are achieved (e.g., thickness). Alternatively, the oven 106 may be eliminated from the coating system 100 in order to applying the wrap 68 before the coating 66 cures.

As shown in FIGS. 6C and 8, the first layer 70 of wrap 68 is applied to an outer surface 67 (FIG. 6B) of the coating 66 such that the first layer 70 of wrap 68 extends around the coating 66 and completely covers the coating 66. Illustratively, the first layer 70 of wrap 68 is wrapped at angle α to the longitudinal axis L of the conductive core 60. The angle α may be approximately 0° to approximately 180° relative to the longitudinal axis L of the conductive core 60 (e.g., 135° in FIG. 6A). As the first layer 70 of wrap 68 is wrapped around the coating 66, the first layer 70 overlaps the portion of the first layer 70 that was previously wrapped around the coating 66. FIG. 6C discloses the overlapped portion 74 of the first layer 70 of wrap 68 in phantom. The overlapped portion 74 may include approximately 10% to approximately 75% overlapping.

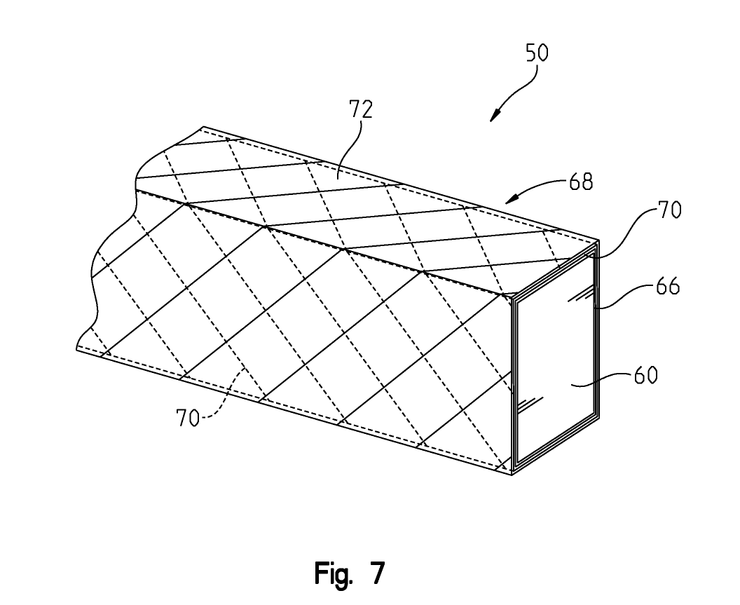

After wrapping the first layer 70 of wrap 68 around the coating 66, the second layer 72 of wrap 68 is wrapped around the first layer 70 of wrap 68, as shown in FIGS. 6D and 8. The second layer 72 of wrap 68 is wrapped at angle β to the longitudinal axis L of the conductive core 60. More particularly, the angle β may be approximately 0° to approximately 180° relative to the longitudinal axis L of the conductive core 60 (e.g., 45° in FIG. 6A). Illustratively, FIG. 7 shows that the first layer 70 of wrap 68 is angularly offset from the second layer 72 of wrap 68 by 90°, such that the first layer 70 forms an X-shaped pattern with the second layer 72. Alternatively, the first and second layers 70, 72 of wrap 68 may be applied in the same orientation.

As the second layer 72 of wrap 68 is wrapped around the first layer 70 of wrap 68, the second layer 72 overlaps the portion of the second layer 72 that was previously wrapped around the first layer 70. FIG. 6D discloses the overlapped portion 74 of the second layer 72 of wrap 68 in phantom. The overlapped portion 74 may include approximately 10% to approximately 75% overlapping. The wrapping process may be repeated until the insulation portion 64 of the conductor wires 50 has the desired properties.

With the first layer 70 and second layer 72 of wrap 68 applied, the conductor wires 50 pass through an oven 112 (e.g., infrared or convection oven) to heat the coating 66 and the wrap 68, which causes melt flow of the coating 66 and forms a mechanical bond within the insulation portion 64. For example, the oven 112 may be operated at approximately 570° F. (approximately 300° C.) to cause melt flow of the coating 66, however, the temperature of the oven 112 is dependent upon the material properties of the coating 66. The conductor wires 50 may be cooled after the coating 66 and the wrap 68 are bonded. For example, the conductor wires 50 may be water cooled by a showerhead 114 or other device that is positioned at the end of the conveyor system 100. Illustratively, a single conveyor system 100 applies both the coating 66 and the wrap 68. Alternatively, the coating 66 and the wrap 68 may be applied by different conveyor systems.

When the conductor wires 50 are insulated, the conductor wires 50 may be cut to the appropriate size for assembly with the stator stack 20. The ends 56, 58 of the conductor wires 50 are inserted into the slots 30a, 30b, 30c, 30d of the stator stack 20 at the insertion end 14 (FIG. 1A) of the stator assembly 10. Furthermore, the conductor wires 50 may be bent to provide a more compact stator assembly 10. The ends 56, 58 of the conductor wires 50 extending outward from the connection end 12 (FIG. 1B) of the stator assembly 10 may be stripped, through conventional processes, to remove the coating 66 and the wrap 68 and expose the conductive core 60 of each end 56, 58. More particularly, the conductive core 60 of the ends 56, 58 of the conductor wires 50 are exposed in order to weld, or otherwise interconnect, the ends 56, 58 to adjacent ends 56, 58 to form a circuit. The conductor wires 50 may be coated with a varnish or other sealant, coating, film, or epoxy, in order to stabilize the conductor wires 50 within the stator stack 20.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An electric machine comprising:
a support defining a longitudinal axis; and
a plurality of conductor wires positioned within the support, each of the conductor wires having an electrically conductive core, an inner electrical insulation coating layer adjacent to the electrically conductive core, an intermediate electrical insulation wrap layer adjacent to the inner electrical insulation coating layer, and an outer electrical insulation wrap layer adjacent to the intermediate electrical insulation wrap layer such that the intermediate electrical insulation wrap layer is positioned between the inner electrical insulation coating layer and the outer electrical insulation wrap layer, the intermediate electrical insulation wrap layer having a first orientation relative to a longitudinal axis of the electrically conductive core, and the outer electrically conductive wrap layer having a second orientation relative to the longitudinal axis of the electrically conductive core.

2. The electric machine of claim 1, wherein an angle of the first orientation is approximately 135° to approximately 170° relative to the longitudinal axis of the electrically conductive core.

3. The electric machine of claim 2, wherein an angle of the second orientation is approximately 10° to approximately 45° relative to the longitudinal axis of the electrically conductive core.

4. The electric machine of claim 3, wherein the first orientation is angularly offset from the second orientation by approximately 90°, such that the outer electrical insulation wrap layer forms an X-shaped pattern with the intermediate electrical insulation wrap layer.

5. The electric machine of claim 1, wherein the electric machine is a motor assembly and the support is a stator stack.

6. The electric machine of claim 1, wherein the inner electrical insulation coating layer is comprised of a first material, and the intermediate and outer electrical insulation wrap layers are comprised of a second material.

7. The electric machine of claim 6, wherein the first material and the second material are selected from the group consisting of polyimide-based insulation, polyamide-imide-based insulation, polyurethane-based insulation, and polyester-based insulation.

8. An electric machine, comprising:
a plurality of conductor wires received within a plurality of apertures of the machine, each of the conductor wires having an electrical insulation portion around an electrically conductive core, the electrical insulation portion including an electrical insulation coating layer, at least one electrical insulation wrap layer, and a bond between the electrical insulation coating layer and the at least one electrical insulation wrap layer.

9. The electric machine of claim 8, wherein the electrical coating layer generally surrounds the electrically conductive core and the at least one electrical insulation wrap layer generally surrounds the electrical insulation coating layer.

10. The electric machine of claim 8, wherein the at least one electrical insulation wrap layer generally surrounds the electrically conductive core and the electrical insulation coating layer generally surrounds the at least one electrical insulation wrap layer.

11. The electric machine of claim 8, wherein the electric machine includes a stator stack, and the plurality of conductor wires are received within the stator stack.

12. The electric machine of claim 8, wherein each of the conductor wires includes an end turn extending from a first end of the machine and a plurality of opposing ends extending from a second end of the machine.

13. The electric machine of claim 8, wherein the electrical insulation coating layer and the at least one electrical insulation wrap layer are comprised of at least one polymeric insulation material.

14. The electric machine of claim 8, wherein the at least one electrical insulation wrap layer includes an inner electrical insulation wrap layer adjacent to the electrical insulation coating layer and an outer electrical insulation wrap layer adjacent to the inner electrical insulation wrap layer.

15. The electric machine of claim 14, wherein each of the conductor wires has a longitudinal axis, the inner electrical insulation wrap layer having a first orientation relative to the longitudinal axis, and the outer electrical insulation wrap layer having a second orientation relative to the longitudinal axis.

16. A method of insulating a conductor wire of an electric machine, comprising the steps of:
providing an electrically conductive core;
applying a liquid electrical insulation coating around the electrically conductive core; and
applying at least one layer of electrical insulation wrap around the electrically conductive core.

17. The method of claim 16, wherein the step of applying at least one layer of electrical insulation wrap includes wrapping a first layer of electrical insulation wrap in a first orientation relative to a longitudinal axis of the electrically conductive core, and wrapping a second layer of electrical insulation wrap in a second orientation relative to the longitudinal axis of the electrically conductive core.

18. The method of claim 16, further comprises the step of activating the electrical insulation coating and the electrical insulation wrap with heat to form a mechanical bond therebetween.

19. The method of claim 18, further comprising the step of cooling the conductor wire.

20. The method of claim 16, wherein the electrical insulation coating is applied to the electrically conductive core prior to applying the at least one layer of electrical insulation wrap.

21. The method of claim 16, wherein the at least one layer of electrical insulation wrap is applied to the electrically conductive core prior to applying the electrical insulation coating.

22. The method of claim 16, wherein the electrical insulation coating is selected from the group consisting of polyimide-based insulation, polyamide-imide-based insulation, polyurethane-based insulation, and polyester-based insulation.

23. The method of claim 16, wherein the electrical insulation wrap is selected from the group consisting of polyimide-based insulation, polyamide-imide-based insulation, polyurethane-based insulation, and polyester-based insulation.

24. A conductor wire for use in an electric machine, comprising:
an electrically conductive core;
an electrical insulation enamel around the electrically conductive core; and
at least one layer of electrical insulation wrap around the electrically conductive core.

25. The conductor wire of claim 24, wherein the at least one layer of electrical insulation wrap includes a first electrical insulation wrap layer adjacent to the electrical insulation enamel layer and a second electrical insulation wrap layer adjacent to the first electrical insulation wrap layer.

26. The conductor wire of claim 25, further comprising a longitudinal axis defined by the electrically conductive core, wherein the first electrical insulation wrap layer has a first orientation relative to the longitudinal axis, and the second electrical insulation wrap layer has a second orientation relative to the longitudinal axis.

27. The conductor wire of claim 24, wherein the electrical insulation enamel is selected from the group consisting of polyimide-based insulation, polyamide-imide-based insulation, polyurethane-based insulation, and polyester-based insulation.

28. The conductor wire of claim 24, wherein the at least one layer of electrical insulation wrap is selected from the group consisting of polyimide-based insulation, polyamide-imide-based insulation, polyurethane-based insulation, and polyester-based insulation.
